(19) United States
(12) Patent Application Publication
(10) Pub. No.: US 2018/0076486 A1
(43) Pub. Date: Mar. 15, 2018

(54) SECONDARY BATTERY

(71) Applicant: NEC CORPORATION, Tokyo (JP)

(72) Inventors: Takehiro NOGUCHI, Tokyo (JP); Kenichi SHIMURA, Tokyo (JP); Shin SERIZAWA, Tokyo (JP); Yuukou KATOU, Tokyo (JP); Takuya HASEGAWA, Tokyo (JP)

(21) Appl. No.: 15/554,556

(22) PCT Filed: Mar. 4, 2016
(86) PCT No.: PCT/JP2016/056751

§ 371 Date: Aug. 30, 2017

(30) Foreign Application Priority Data
Mar. 5, 2015 (JP) 2015-043668

(51) Int. Cl. H01M 10/0569; H01M 10/052; H01M 10/058; H01M 4/505; H01M 4/525; H01M 10/0567; H01M 4/131

(52) U.S. Cl. CPC H01M 10/0569; H01M 10/052; H01M 10/058; H01M 2/16; H01M 4/525; H01M 10/0567; H01M 4/131; H01M 4/505

(57) ABSTRACT

A lithium ion secondary battery excellent in cycle characteristics and rate characteristics is provided. The present invention relates to a lithium secondary battery having an electrolyte solution comprising one or more compounds selected from a fluorinated ether and a fluorinated phosphate ester and a separator comprising an aramid resin.

### TECHNICAL FIELD

The present invention relates to a secondary battery using fluorinated ethers and fluoridated phosphate esters for electrolyte solution and a method of producing the same.

### BACKGROUND ART

Lithium ion secondary batteries, which feature small size and large capacity, have been widely used as power supplies for electronic devices such as mobile phones and notebook computers and have contributed to enhancing convenience of mobile IT devices. In recent years, larger-scale applications, such as power supplies for driving motorcycles and automobiles and storage cells for smart grids, have attracted attention. As demand for lithium ion secondary batteries are increased and batteries are used in more various fields, characteristics such as a further enhancement in the energy density, lifetime characteristics for endurance over long-term use, and usability in a wide range of temperature condition are demanded.

Since surfaces of a positive electrode and a negative electrode contacting with electrolyte solution become an environment where reduction effect or oxidation effect of the electrolyte solution is strong in the case of charging and discharging of a lithium ion secondary battery, reduction of the electrolyte solution is unavoidable on the surface of the electrode and the electrolyte solution is decomposed through a side reaction with materials structuring an electrode (electrode active materials). Thus, there has been a long-term problem that degradation of battery capacity occurs in repeating charge and discharge of lithium ion secondary batteries. Especially, these problems are recognized markedly in lithium ion batteries using a high voltage positive electrode which attracts attention as to higher energy density in recent years.

Fluorinated ethers and fluorinated phosphate esters are used for electrolyte solution to improve such capacitance degradation (cycle characteristics) in charge and discharge cycles. Patent Document 1 discloses that cycle characteristics of secondary batteries can be improved by using an electrolyte solution where fluorinated ethers are mixed with propylene carbonate and ethylene carbonate. Patent Document 2 discloses that a secondary battery having high energy density and improved cycle characteristics is obtained in the case of using an electrolyte solution comprising fluorine-containing phosphate esters in a lithium ion secondary battery having a positive electrode comprising a positive electrode active material operable at a high potential of 4.5V or higher vs. Lithium.

### CITATION LIST

### Patent Document

Patent Document 1: Japanese Patent Laid-Open Publication No. H11-26015

Patent Document 2: International Publication WO No. 2012/077712

### SUMMARY OF INVENTION

### Technical Problem

In general, capacity of a battery is decreased because of high internal resistance as the discharge rate is set higher. A discharge capacity retention rate in the case of setting the discharge rate higher is referred to as rate characteristics, which are used as a battery evaluation index. Improvement of rate characteristics is also an important element to obtain batteries with high energy density.

However, although the lithium ion secondary batteries using fluorinated ethers and/or fluorinated phosphate esters for the electrolyte solution is excellent particularly in cycle characteristics in the case of high energy density, there are problems that the conductivity of the electrolyte solution is low and further improvement of the rate characteristics is required.

An object of the present invention is to provide secondary batteries solving the above problems.

### Solution to Problem

The present invention relates to the following matters.

A lithium ion secondary battery having an electrolyte solution comprising one or more compounds selected from a fluorinated ether denoted by the following formula (1) and a fluorinated phosphate ester denoted by the following formula (2), and a separator comprising an aramid resin.

R₄—O—R₅ (1)

(In the formula (1), R₄ and R₅ each independently represent alkyl group or fluorinated alkyl group, and at least one of R₄ and R₅ is fluorinated alkyl group.)

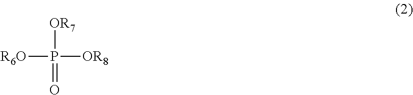

(In the formula (2), R₆, R₇, and R₈ each independently represent non-substituted or substituted alkyl group, at least one of R₆, R₇, and R₈ is fluorinated alkyl group, and a carbon atom in R₆ and a carbon atom in R₇ may be bonded through a single bond or a double bond to form a cyclic structure.)

### Advantageous Effect of Invention

According to the present invention, it is possible to provide a lithium ion secondary battery using fluorinated ethers and/or fluorinated phosphate esters for the electrolyte solution and having excellent rate characteristics.

### BRIEF DESCRIPTION OF DRAWING

FIG. 1 is a schematic diagram showing an example of the present invention.

FIG. 2 is an exploded perspective view showing the basic structure of a film-packaged battery.

FIG. 3 is a cross-sectional view schematically showing a cross section of the battery in FIG. 2.

### DESCRIPTION OF EMBODIMENTS

The present inventors have studied separators of secondary batteries in order to improve the rate characteristics. The separators are installed in a battery cell for the purpose of providing a function of transmitting charge carriers while preventing contact between the electrodes of the battery and a shut-down function during heat generation due to a short of the battery and the like. However, since the separator itself causes internal resistance of the battery, it may be important to properly set various properties of the separator such as thickness, pore diameter and the like depending on voltage and capacity of the battery to be used in order to improve the rate characteristics. In addition, since it is needed to retain the electrolyte solution in the pore of the separator to transmit charge carriers, the present inventors consider that affinity between the separator and the electrolyte solution is also important to improve the rate characteristics, and have also studied raw materials of the separator.

As a result, the present inventors found that rate characteristics of the battery can be improved by using a separator comprising aramid resin in the battery using fluorinated ethers and/or fluorinated phosphate esters for the electrolyte solution.

An example of structure of the secondary battery according to the present invention will be described below.

### (Separator)

The separator of the present embodiment comprises aramid resin, preferably comprises the aramid resin in an amount of at least 50 mass % or more, more preferably 80 mass % or more, most preferably 90 mass % or more. Aramid resin has high heat resistance and safety can be improved by using it for a separator particularly in lithium ion secondary batteries with high energy density.

Aramid is an aromatic polyamide in which one or two or more aromatic groups are directly linked by an amide bond. As the aromatic group, for example, a phenylene group may be exemplified, and two aromatic rings may be bonded by oxygen, sulfur or an alkylene group (for example, methylene group, ethylene group, propylene group or the like). These divalent aromatic groups may have a substituent group and examples of the substituent group include alkyl group (for example, methyl group, ethyl group, propyl group or the like), alkoxy group (for example, methoxy group, ethoxy group, propoxy group or the like), and halogen (chloro group or the like). The aramid used in the present invention may be any of para-type or meta-type.

Examples of the aramid preferably used in the present embodiment include polymetaphenylene isophthalamide, polyparaphenylene terephthalamide, copolyparaphenylene 3,4′-oxydiphenylene terephthalamide, and the like.

Any structure such as microporous film and fiber assembly, for example, fabric or nonwoven fabric, may be adopted for the separator as long as the separator has gaps providing high air permeability. Among them, microporous film is prefer in view of the rate characteristics because it has high mechanical strength and can be formed to thin film.

The separator needs to have a certain degree or more of film thickness to provide mechanical strength and for example, the film thickness is preferably 5 μm or more, more preferably 10 μm or more, and still more preferably 15 μm or more. On the other hand, in view of increasing energy density and decreasing internal resistance in the secondary battery, the separator is preferably thin, for example 50 μm or less, more preferably 30 μm or less, and still more preferably 25 μm or less.

In addition, the separator comprising the aramid resin according to the present embodiment preferably has a porosity of 55% or more, and more preferably 70% or more. The bulk density is measured in accordance with JIS P 8118 and the porosity of the separator can be calculated as follows:

Porosity (%)=[1−(bulk density ρ (g/cm³)/theoretical density ρ₀ of the material (g/cm³))]×100

Other measurement methods include a direct observation method using an electron microscope and a press fitting method using a mercury porosimeter. By setting the porosity within the above range, it is possible to improve the low temperature rate characteristics of the secondary battery, in particular, the low temperature rate characteristics of the secondary battery using an electrolyte solution whose viscosity increases at low temperature. A lithium ion secondary battery which is excellent in the low temperature rate characteristics can also be suitably used for a use application under a low temperature environment such as in vehicle application.

Gurley value of the separator is preferably 120 second or less, more preferably 10 second or less, and most preferably 2 second or less. Gurley value is an index expressing an air-permeability and means the number of seconds required to pass a specific volume of air at a specific pressure through a test piece. It can be measured in accordance with JIS P 8117. Low Gurley value is preferable in view of the rate characteristics.

### (Electrolyte Solution)

The electrolyte solution of the present embodiment comprises a non-aqueous solvent and a lithium salt.

The non-aqueous solvent of the present embodiment comprises fluorinated ethers and/or fluorinated phosphate esters. More specifically, the fluorinated ethers used in the present embodiment include fluorinated ether compounds denoted by the following formula (1).

R₄—O—R₅ (1)

(In the formula (1), R₄ and R₅ each independently represent alkyl group or fluorinated alkyl group, and at least one of R₄ and R₅ is fluorinated alkyl group.)

In the formula (1), n₁ that is the number of carbon atoms of R₄ and n₂ that is the number of carbon atoms of R₅ are preferably satisfy 1≦n₁≦8 and 1≦n₂≦8, respectively. In addition, it is preferred that the total number of carbon atoms of R₄ and R₅ is preferably 10 or less.

In addition, the fluorinated alkyl groups are those in which preferably 50% or more, and more preferably 60% or more of hydrogen atoms in the corresponding unsubstituted alkyl group are substituted with fluorine atom(s). A large content of the fluorine atoms gives more remarkable improvement in voltage resistance, and therefore even when a positive electrode active material operating at a high potential is used, the deterioration of the battery capacity after cycles can be more effectively reduced.

Among the above fluorinated ethers, a fluorinated ether compounds denoted by the following formula (1-1) are more preferable.

X¹—(CX²X³)ₙ—O—(CX⁴X⁵)ₘ—X⁶ (1-1)

(In the formula (1-1), n and m each independently denote 1 to 8. X¹ to X⁶ are each independently a fluorine atom or a hydrogen atom. However, at least one of X¹ to X³ is a fluorine atom and at least one of X⁴ to X⁶ is a fluorine atom. Further, when n is 2 or more, a plurality of existing X² and X⁸ are, in each case, independent to one another, and when m is 2 or more, a plurality of existing X⁴ and X⁵ are, in each case, independent to one another.)

The examples of fluorinated ether compounds include CF₃OCH₃, CF₃OC₂H₅, F(CF₂)₂OCH₃, F(CF₂)₂OC₂H₅, CF₃(CF₂)CH₂O(CF₂)CF₃, F(CF₂)₃OCH₃, F(CF₂)₃OC₂H₅, F(CF₂)₄OCH₈, F(CF₂)₄OC₂H₅, F(CF₂)₅OCH₃, F(CF₂)₅OC₂H₅, F(CF₂)₈OCH₃, F(CF₂)₅OC₂H₅, F(CF₂)₉OCH₈, CF₃CH₂OCH₃, CF₃CH₂OCHF₂, CF₃CF₂CH₂OCH₃, CF₃CF₂CH₂OCHF₂, CF₃CF₂CH₂O(CF₂)₂H, CF₃CF₂CH₂O(CF₂)₂F, HCF₂CH₂OCH₃, (CF₃)(CF₂)CH₂O(CF₂)₂H, H(CF₂)₂OCH₂CH₃, H(CF₂)₂OCH₂CF₃, H(CF₂)₂CH₂OCHF₂, H(CF₂)₂CH₂O(CF₂)₂H, H(CF₂)₂CH₂O(CF₂)₃H, H(CF₂)₃CH₂O(CF₂)₂H, H(CHF)₂CH₂O(CF₂)₂H, (CF₃)₂CHOCH₃, (CF₃)₂CHCF₂OCH₃, CF₃CHFCF₂OCH₃, CF₃CHFCF₂OCH₂CH₃, CF₃CHFCF₂CH₂OCHF₂, CF₃CHFCF₂OCH₂(CF₂)₂F, CF₃CHFCF₂OCH₂CF₂CF₂H, H(CF₂)₄CH₂O(CF₂)₂H, CH₃CH₂O(CF₂)₄F, F(CF₂)₄CH₂O(CF₂)₂H, H(CF₂)₂CH₂OCF₂CHFCF₃, F(CF₂)₂CH₂OCF₂CHFCF₃, H(CF₂)₄CH₂O(CF₂)H, CF₃OCH₂(CF₂)₂F, CF₃CHFCF₂OCH₂(CF₂)₃F, CH₃CF₂OCH₂(CF₂)₂F, CH₃CF₂OCH₂(CF₂)₃F, CH₃O(CF₂)₅F, F(CF₂)₃CH₂OCH₂(CF₂)₃F, F(CF₂)₂CH₂OCH₂(CF₂)₂F, H(CF₂)₂CH₂OCH₂(CF₂)₂H, CH₃CF₂OCH₂(CF₂)₂H, C₃H₇OCF₂CF₂H, (CH₃)₂CHOCF₂CF₂H, C₂H₅OCF₂CHFCF₃, CH₅CF₂OCH₂CF₂CF₃, CH₃CF₂OCH₂CF₂CF₂CF₃, C₂H₅OC₄F₉, CF₃CHFCF₂CH₂OCF₂H, CF₂HCF₂OCH₂CF₂CF₃, CF₃CHFCF₂OCF₂CH₃, CF₂HCF₂OCH₂CF₃, CF₂HCF₂CH₂OCF₂CHFCF₃, CF₃CF₂CH₂OCH₂F₂CF₃, C₄F₃OCH₃, CF₃CHFCF₂OCH₂CF₃, CF₃CF₂CH₂OCF₂CF₂H, CF₃CHFOCF₂CF₂H, CF₃CF₂CF₂CH₂OCH₂CF₂CF₂CF₃, CF₃CF₂CH₂OCF₂CHFCF₃, CH₃OC₆F₁₃, CF₃CHFCF₂OCH₂CF₂CF₂CF₃, CF₃CF₂CF₂CH₂OCF₃, CF₃CF₂CF₂CHFOCHFCF₂CF₂CF₃, C₅F₇OCHFCF₃, CH₃CF₂OCF₂CF₂H, CH₂FCF₂OCH₂CF₃, HCF₂CF₂CH₂OCH₂CH₂OCH₃, H(CF₂CF₂)₂CH₂OCH₂CH₂OCH₃, CF₃CF₂CH₂OCH₂CH₂OCH₃, H(CF₂CF₂)₃CH₂OCH₂CH₂OCH₃, CHF₃CF₂CH₂OCH₂CF₂CF₃, CF₂CF₂CH₂OCH₂CF₂CF₂H and the like.

The fluorinated ether compounds denoted by the formula (1) may be used alone or in mixture of two or more thereof.

The content of the fluorinated ether compounds denoted by the formula (1) contained in the non-aqueous electrolyte solution is 5 to 80 volume % in the non-aqueous electrolyte solution. When the content is 5 volume % or more, the effect of enhancing the voltage resistance is improved. When the content is 80 volume % or less, the ionic conductivity of the electrolyte solution is improved, and the charge and discharge rate of the battery becomes better. The total content of the fluorine-containing ether compounds represented by the general formula (1) is more preferably 20 to 75 volume %, and still more preferably 30 to 70 volume % in the electrolyte solution.

The fluorinated phosphate esters used hi the present embodiment include compounds denoted by the following formula (2).

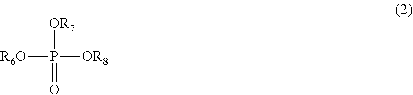

(In the formula (2), R₆, R₇, and R₈ each independently represent non-substituted or substituted alkyl group, at least one of R₆, R₇, and R₈ is fluorinated alkyl group, and a carbon atom of R₆ and a carbon atom of R₇ may be bonded through a single bond or a double bond to form a cyclic structure.)

In the formula (2), the numbers of carbon atoms of R₆, R₇, and R₈ are preferably each independently 1 to 3. At least one of R₆, R₇, and R₈ is preferably a fluorine-substituted alkyl group in which 50% or more of hydrogen atoms in the corresponding unsubstituted alkyl group are substituted with a fluorine atom(s). In addition, more preferably, all of R₆, R₇, and R₈ are a fluorine-substituted alkyl group, and R₆, R₇, and R₈ are a fluorine-substituted alkyl group in which 50% or more of hydrogen atoms in the corresponding unsubstituted alkyl group are substituted with a fluorine atom(s). This is because a large content of the fluorine atoms further increases the voltage resistance, and even when a positive electrode active material which operates at a high potential is used, it can further decrease the capacity deterioration of the battery after cycles.

Examples of the fluorinated phosphate ester include, but are not particularly limited to, fluorinated alkyl phosphate ester compounds, such as tris (trifluoromethyl) phosphate, tris (pentafluoroethyl) phosphate, tris (2,2,2-trifluoroethyl) phosphate, tris (2,2,3,3-tetrafluoropropyl) phosphate, tris (3,3,3-trifluoropropyl) phosphate, tris (2,2,3,3,3-pentafluoropropyl) phosphate and the like. Among these, as the fluorinated phosphate ester compound, tris(2,2,2-trifluoroethyl) phosphate is preferred. The fluorinated phosphate ester may be used singly or in combination of two or more.

Fluorinated phosphate esters have advantages that they do not easily decompose because of high oxidation resistance. In addition, it is considered that the effect of suppressing gas generation also exists. On the other hand, since the viscosity is high and the dielectric constant is relatively low, there is a problem that the conductivity of the electrolyte solution is decreased in the case where the content is too much. For these reasons, the content of the fluorinated phosphate esters in the non-aqueous electrolyte solution is preferably 1 to 50 volume %, more preferably 5 to 40 volume %, and still more preferably 10 to 30 volume %, The fluorinated phosphate esters may be used for the electrolyte solution in combination with the fluorinated ethers. In particular, the compatibility of the fluorinated ethers with other solvents can be enhanced by comprising the fluorinated phosphate esters in an amount of 5 volume % or more.

It is preferable that one or more other non-aqueous solvents are used and mixed in addition to the fluorinated ethers and/or the fluorinated phosphate esters. Other nonaqueous solvents include carbonate ester compounds, sulfone compounds, carboxylate ester compounds and the like.

Examples of the carbonate ester compound include compounds denoted by the following formula (3).

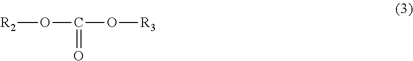

(In the formula (3), R₂ and R₃ each independently represent a substituted or non-substituted alkyl group. A carbon atom of R₂ and a carbon atom of R₃ may be bonded through a single bond or a double bond to form a cyclic structure. In addition, a part of hydrogens of R₂ and R₃ may be substituted with fluorine.)

The carbonate ester compounds denoted by the formula (3) preferably are ethylene carbonate, propylene carbonate, butylene carbonate, vinylene carbonate, and compounds having those cyclic carbonate ester structures, where a part or all of hydrogens is substituted with fluorine atom.

Examples of the sulfone compound include compounds denoted by the following formula (4).

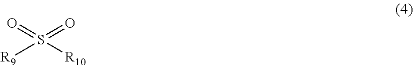

(In the formula (4), R₉ and R₁₀ each independently represent a substituted or non-substituted alkyl group. A carbon atom of R₉ and a carbon atom of R₁₀ may be bonded through a single bond or a double bond to form a cyclic structure).

The cyclic sulfone compounds denoted by the formula (4) preferably include tetramethylene sulfone (sulfolane), pentamethylene sulfone, hexamethylene sulfone and the like. In addition, the cyclic sulfone compounds having substituted groups are preferably 3-methyl sulfolane, 2,4-dimethyl sulfolane and the like. These materials have the advantages of suppressing the decomposition of the electrolyte solution under high voltage due to their excellent oxidation resistance and being excellent in dissolving/dissociating lithium salts due to their relatively high dielectric constant.

The sulfone compound may be a chain sulfone compound. Examples of the chain sulfone compound include ethyl methyl sulfone, ethyl isopropyl sulfone, ethyl isobutyl sulfone, dimethyl sulfone, diethyl sulfone, methyl isopropyl sulfone and the like. Among them, dimethyl sulfone, ethyl methyl sulfone, ethyl isopropyl sulfone, and ethyl isobutyl sulfone are preferred. These materials have the advantages of suppressing the decomposition of the electrolyte solution under high voltage due to their excellent oxidation resistance and being excellent in dissolving/dissociating lithium salts due to their relatively high dielectric constant.

Examples of the carboxylate ester compound include compounds denoted by the following formula (5).

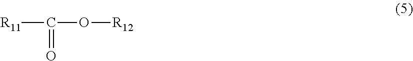

In the formula (5), R₁₁ and R₁₂ each independently represent a substituted or non-substituted alkyl group. A carbon atom of R₁₁ and a carbon atom of R₁₂ may be bonded through a single bond or a double bond to form a cyclic structure. In addition, a part of hydrogens of R₁₁ and R₁₂ may be substituted with fluorine.)

Examples of the carboxylate ester include, but are not particularly limited to, ethyl acetate, methyl propionate, ethyl formate, ethyl propionate, methyl butyrate, ethyl butyrate, methyl acetate, methyl formate and the like. To enhance the voltage resistance, the compounds where hydrogen is substituted with fluorine are preferable. These compounds are, for example, ethyl pentafluoropropionate, ethyl 3,3,3-trifluoropropionate, methyl 2,2,3,3-tetrafluoropropionate, 2,2-difluoroethyl acetate, methyl heptafluoroisobutyrate, methyl 2,3,3,3-tetrafluoropropionate, methyl pentafluoropropionate, methyl 2-(trifluoromethyl)-3,3,3-trifluoropropionate, ethyl heptafluorobutyrate, methyl 3,3,3-trifluoropropionate, 2,2,2-trifluoroethyl acetate, isopropyl trifluoroacetate, tert-butyl trifluoroacetate, ethyl 4,4,4-trifluorobutyrate, methyl 4,4,4-trifluorobutyrate, butyl 2,2-difluoroacetate, ethyl difluoroacetate, n-butyl trifluoroacetate, 2,2,3,3-tetrafluoropropyl acetate, ethyl 3-(trifluoromethyl)butyrate, methyltetrafluoro-2-(methoxy)propionate, 3,3,3-trifluoropropyl 3,3,3-trifluoropropionate, methyl difluoroacetate, 2,2,3,3-tetrafluoropropyl trifluoroacetate, 1H, 1H-heptafluorobutyl acetate, methyl heptafluorobutyrate and ethyl trifluoroacetate. Among these, from the viewpoint of the voltage resistance, the boiling point and the like, preferable are methyl 2,2,3,3-tetrafluoropropionate, 2,2,3,3-tetrafluoropropyl trifluoroacetate and the like.

The chain carboxylate ester has an advantage of low viscosity when the number of carbon atoms is small, but the boiling point also tends to be lower. A chain carboxylate ester having a low boiling point may be evaporated during high temperature operation of the battery. On the other hand, when the number of carbon atoms is too large, the viscosity may become high, resulting in a decrease of electrical conductivity. For this reason, the number of carbon atoms of the carboxylate ester is preferably 3 or more and 12 or less. In addition, the oxidation resistance can be improved, by fluorine substitution. When the amount of fluorine substitution is low, a capacity retention ratio of the battery may fall or gas may be generated due to a reaction with the positive electrode of a high potential. On the other hand, if the amount of fluorine substitution is too high, the solution into the electrolyte solution may be difficult, or the boiling point may be decreased. For these reasons, the amount of fluorine substitution regarding hydrogen atoms is preferably 1% or more and 90% or less, more preferably 10% or more and 85% or less, and still more preferably 20% or more and 80% or less.

Examples of Other solvents other than those described above mixed in addition to the fluorinated ethers and/or the fluorinated phosphate esters include γ-lactones such as γ-butyrolactone, chain ethers such as 1,2-ethoxyethane (DEE) and ethoxymethoxyethane (EME), cyclic ethers such as tetrahydrofuran and 2-methyltetrahydrofuran aprotic organic solvents such as dimethylsulfoxide, 1,3-dioxolane, formamide, acetamide, dimethylformamide, dioxolane, acetonitrile, propylnitrile, nitromethane, ethyl monoglyme, phosphate triester, trimethoxymethane, dioxolane derivatives, 1,3-dimethyl-2-imidazolidinone, 3-methyl-2-oxazolidinone, propylene carbonate derivatives, tetrahydrofuran derivatives, ethyl ethers, 1,3-propane sulton, anisole, N-methylpyrrolidone and the like.

LiPF₆, LiAsF₆, LiAlCl₄, LiClO₄, LiBF₄, LiSbF₆, LiCF₃SO₃, LiC₄F₉CO₃, LiC(CF₃SO₂)₃, LiN(CF₃SO₂)₂, LiB₁₀Cl₁₀, lithium lower aliphatic carboxylate, chloroborane lithium, lithium tetraphenylborate, LiCl, LiBr, LiI, LiSCN and the like may use as the lithium salt.

### (Positive Electrode)

In the present embodiment, the positive electrode active material is not particularly limited as long as it can intercalate lithium ions in charging and deintercalate them, in discharging, and those known can be used.

Examples of the positive electrode active material include lithium manganates having a laminate structure or a spinel structure such as LiMnO₂ and LiₓMn₂O₄ (0<x<2); LiCoO₂, LiNiO₂ or those obtained by replacing a part of these transition metals of these with another metal; lithium transition metal, oxides in which a particular transition metal does not exceed a half such as LiNi_{1/3}Co_{1/3}Mn_{1/3}O₂; those having an olivine structure such as LiFePO₄; and those containing Li in an amount excessively larger than the stoichiometric composition (amount) in these lithium transition metal oxides. Particularly, Li_{α}Ni_{β}Co_{γ}Al_{δ}O₂ (1≦α≦1.2, α+β+γ+δ=2, β≧0.7, γ≦0.2) or Li_{α}Ni_{β}Co_{γ}Mn_{δ}O₂ (1≦α≦1.2, α+β+γ+δ=2, β≦0.6, γ≦0.2) is preferable. The materials can be used alone or in combination of two types or more.

It is preferable to use a positive electrode active material operable at 4.5V or higher vs. Lithium in the positive electrode in the present invention. Since the electrolyte solution comprising the fluorinated ethers and/or the fluorinated phosphate esters is hardly deteriorated under a high voltage, it is more effective in high energy density batteries using the positive electrode active material operable at 4.5V or higher vs. Lithium.

As the positive electrode active material which operates at a potential of 4.5 V or higher, a litbiunrmanganese composite oxide represented by the following formula (6) can be used, for example.

Liₐ(MₓMn_{2-x-y}Y_{y})(Q_{4-w}Z_{w}) (6)

(in the formula (6), 0.4≦x≦1.2, 0≦y, x+y<2, 0≦a≦1.2, 0≦w≦w≦1, M is at least one selected from the group consisting of Co, Ni, Fe, Cr, and Cu, Y is at least one selected from the group consisting of Li, B, Na, Mg, Al, Ti, Si, K, and Ca. Z is at least one of F and CL)

As the lithium manganese composite oxides represented by the formula (6), specifically, preferable examples thereof include LiNi_{0.5}Mn_{1.5}O₄, LiCrMnO₄, LiFeMnO₄, LiCoMnO₄, LiCu_{0.5}Mn_{1.5}O₄ and the like. These positive electrode active materials have a high capacity.

The positive electrode active material operating at a potential of 4.5 V or higher is preferably a lithium manganese composite oxide represented by the following formula (6-1) from the viewpoint of obtaining a sufficient capacity and extending the life time.

LiNiₓMn_{2-x-y}A_{y}O₄ (6-1)

(In the formula (6-1), 0.4<x<0.6, 0<y<0.3, and A is at least one selected from the group consisting of Li, B, Na, Mg, Al, Ti, and Si,)

Furthermore, examples of the olivine-type positive electrode active material include those represented by the following formula (7).

LMPO₄ (7)

(In the formula (7), M is at least one of Co and Ni.)

Among the olivine-type positive electrode active materials, LiCoPO₄, LiNiPO₄ and the like are preferable.

In addition, the positive electrode active material which operates at a potential of 4.5 V or higher also includes those having a layer structure, including those represented by the following formula (8), for example.

Liₐ(LiₓM_{1-x-z}Mn_{z})O₂ (8)

(In the formula (8), 0≦x<0.3, 0.3≦z≦0.7, 0≦a≦1, and M is at least one selected from the group consisting of Co, Ni, and Fe.)

In addition, as the positive electrode active material which operates at a potential of 4.5 V or higher, Si composite oxides are also raised, including those represented by the following formula (9), for example.

Li₂MSiO₄ (9)

(In the formula (9), M is at least one selected from the group consisting of Mn, Fe and Co.)

The positive electrode active material may be selected from some viewpoints. From the viewpoint of achieving higher energy density, it is preferable to contain a high capacity compound. Examples of the high capacity compound include lithium acid nickel (LiNiO₂), or lithium nickel composite oxides in which a part of the Ni of lithium acid nickel is replaced by another metal element, and layered lithium nickel composite oxides represented by the following formula (A) are preferred.

Li_{y}Ni₍₁₋ₓ₎MₓO₂ (A)

(In the formula (A), 0≦x<1, 0<y≦1.2, and M is at least one element selected from the group consisting of Co, Al, Mn, Fe, Ti, and B.)

From the viewpoint of high capacity, it is preferred that the content of Ni is high, that is, x is preferably less than 0.5, more preferably 0.4 or less in the formula (A). Examples of such compounds include Li_{α}Ni_{β}Co_{γ}Mn_{δ}O₂ (0<α≦1.2, preferably 1≦α≦1.2, β+γ+δ=1, β≧0.7, and γ≦0.2) and Li_{α}Ni_{β}Co_{γ}Al_{δ}O₂ (0<α≦1.2, preferably 1≦α≦1.2, β+γ+δ=1, β≧0.6, preferable β≧0.7, and γ≦0.2) and particularly include LiNi_{β}Co_{γ}Mn_{δ}O₂ (0.75≦β≦0.85, 0.05≦γ≦0.15, and 0.10≦δ≦0.20). More specifically, for example, LiNi_{0.8}Co_{0.05}Mn_{0.15}O₂, LiNi_{0.8}Co_{0.1}Mn_{0.1}O₂, LiNi_{0.8}Co_{0.15}Al_{0.05}O₂, and LiN_{0.8}Co_{0.1}Al_{0.1}O₂ may be preferably used.

In addition, from the viewpoint of thermal stability, it is also preferred that the content of Ni does not exceed 0.5, that is, x is 0.5 or more in the formula (A). In addition, it is also preferred that particular transition metals do not exceed half. Examples of such compounds include Li_{α}Ni_{β}Co_{γ}Mn_{δ}O₂ (0>α≦1.2, preferably 1≦α≦1.2, β+γ+δ=1, 0.2≦β≦0.5, 0.1≦γ≦0.4, and 0.1≦δ≦0.4). More specific examples may include LiNi_{0.4}Co_{0.3}Mn_{0.3}O₂ (abbreviated as NCM433), LiNi_{1/3}Co_{1/3}Mn_{1/3}O₂, LiNi_{0.5}Co_{0.2}Mn_{0.3}O₂ (abbreviated, as NCM523), and LiNi_{0.3}Co_{0.3}Mn_{0.2}O₂ (abbreviated as NCM532) (also including these compounds in which the content of each transition metal fluctuates by about 10%).

In addition, two or more compounds represented by the formula (A) may be mixed and used, and, for example, it is also preferred, that NCM532 or NCM523 and NCM433 are mixed in the range of 9:1 to 1:9 (as a typical example, 2:1) and used. Further, by mixing a material in which the content of Ni is high (x is 0.4 or less) and a material in which the content of Ni does not exceed 0.5 (x is 0.5 or more, for example, NCM433), a battery having a high capacity and high thermal stability can also be formed.

The positive electrode may be produced, for example, by applying to an electrode current collector a positive electrode slurry which is prepared by mixing a positive electrode active material, a positive electrode binder and if necessary, a conductive assisting agent.

Examples of the conductive assisting agent include carbon materials such as acetylene black, carbon black, fibrous carbon and graphite, metallic material such as Al, powder of electrically conductive oxides and the like.

Examples of the positive electrode binder include, but are not particularly limited to, polyvinylidene fluoride (PVdF), vinyiidene fluoride-hexafluoropropylene copolymer, vinylidene fluoride-tetrafluoroethylene copolymer, styrene-butadiene copolymer rubber, polytetrafluoroethylene, polypropylene, polyethylene, polyimide, polyamideimide and the like.

The content of the conductive assisting agent in the positive electrode may be, for example, 1 to 10% by mass. The content of the binder in the positive electrode may be, for example, 1 to 10% by mass. When the content is within the range, the ratio of the amount of the active material in the electrode is easily ensured sufficiently and enough capacity per unit mass is easily obtained.

The positive electrode current collector is not particularly limited, but from the electrochemical stability, examples thereof include aluminum, nickel, copper, silver and alloys thereof are preferable. The shape of the positive electrode current collector includes foil, flat plate and mesh.

### (Negative Electrode)

Examples of the negative electrode active material of the present embodiment include, but are not particularly limited to, a carbon material that can absorb and desorb a lithium ion, a metal that can be alloyed with lithium, a metal oxide that can absorb and desorb a lithium ion and the like.

Examples of the carbon material include carbon, amorphous carbon, diamond-like carbon, a carbon nanotube, a composite thereof or the like. Herein, carbon having high crystallinity has a high electric conductivity, and is excellent in adhesiveness with a positive electrode current collector made of a metal such as copper and excellent in voltage flatness. On the other hand, since amorphous carbon having low crystallinity has relatively low volume expansion, it has a high effect of reducing the volume expansion of the negative electrode as a whole, and hardly causes deterioration due to non-uniformity such as crystal grain boundary or defect.

A negative electrode containing the metal or the metal oxide is preferred in the point that it is possible to improve the energy density of the battery and to increase the per-unit-weight-or the per-unit-volume-capacity of the battery.

Examples of the metal include Al, Si, Pb, Sn, In, Bi, Ag, Ba, Ca, Hg, Pd, Pt, Te, Zn, La, an alloy of two or more thereof or the like. These metals and alloys may be used in combination of two or more. In addition, these metals and alloys may comprise one or more non-metal elements.

Examples of the metal oxide include silicon oxide, aluminum oxide, tin oxide, indium oxide, zinc oxide, lithium oxide, a composite thereof or the like. In the present embodiment, the negative electrode active material preferably comprises tin oxide or silicon oxide, more preferably silicon oxide. This is because silicon oxide is relatively stable and is hardly caused to react with other compounds. In addition, one or two or more elements selected from nitrogen, boron and sulfur may also be added to the metal oxide in an amount of, for example, 0.1 to 5% by mass. Such addition can improve the electric conductivity of the metal oxide.

Also, for the negative electrode active material, not a single material but a plurality of materials as a mixture can be used. For example, the same kind of materials such as graphite and amorphous carbon may be mixed, and different kinds of materials such as graphite and silicon may be mixed.

Examples of the negative electrode binder include, but are not particularly limited to, polyvinylidene fluoride, vinylidene fluoride-hexafluoropropylene copolymer, vinylidene fluoride-tetrafluoroethylene copolymer, styrene-butadiene copolymer rubber, polytetrafluoroethylene, polypropylene, polyethylene, polyimide, polyamide imide, and polyacrylic acid can be used. The amount of the negative electrode binder used is preferably 0.5 to 25 parts by mass based on 100 parts by mass of the negative electrode active material from the viewpoint of trade-off relations between “sufficient binding strength” and “high energy”,

Aluminum, nickel, stainless steel, chromium, copper, silver, and alloys thereof are preferable for the negative electrode current collector in terms of electrochemical stability. Examples of its shape include foil, plate, and mesh.

### (Vehicle)

The lithium ion secondary battery or the assembled battery according to the present embodiment can be used in vehicles. Vehicles according to the present embodiment include hybrid vehicles, fuel cell vehicles, electric vehicles (besides four-wheel vehicles (cars, trucks, commercial vehicles such as buses, light automobiles, etc.) two-wheeled vehicle (bike) and tricycle), and the like. The vehicles according to the present embodiment is not limited to automobiles, it may be a variety of power source of other vehicles, such as a moving body like a train.

### (Power Storage Equipment)

The lithium ion secondary battery or the assembled battery according to the present embodiment can be used in power storage equipment. The power storage devices according to the present embodiment include, for example, those which is connected between the commercial power supply and loads of household appliances and used as a backup power source or an auxiliary power in the event of power outage or the like, or those used as a large scale power storage that stabilize power output with large time variation supplied by renewable energy, for example, solar power generation.

### (Method for Manufacturing Lithium Ion Secondary Battery)

The lithium ion secondary battery according to the present embodiment can be manufactured in accordance with a usual manner. An example of a method for manufacturing the secondary battery will be described by taking a method for manufacturing the layered laminate type lithium ion secondary battery as an example. Firstly, the electrode element is formed by, in dry air or an inert gas atmosphere, disposing the negative electrode and the positive electrode to oppose to each other via the separator. Then, the electrode element is housed in the outer package (container) and the electrolyte solution is injected there to impregnate the electrodes with the electrolyte solution. After that, the opening of the package is sealed to complete the lithium ion secondary battery.

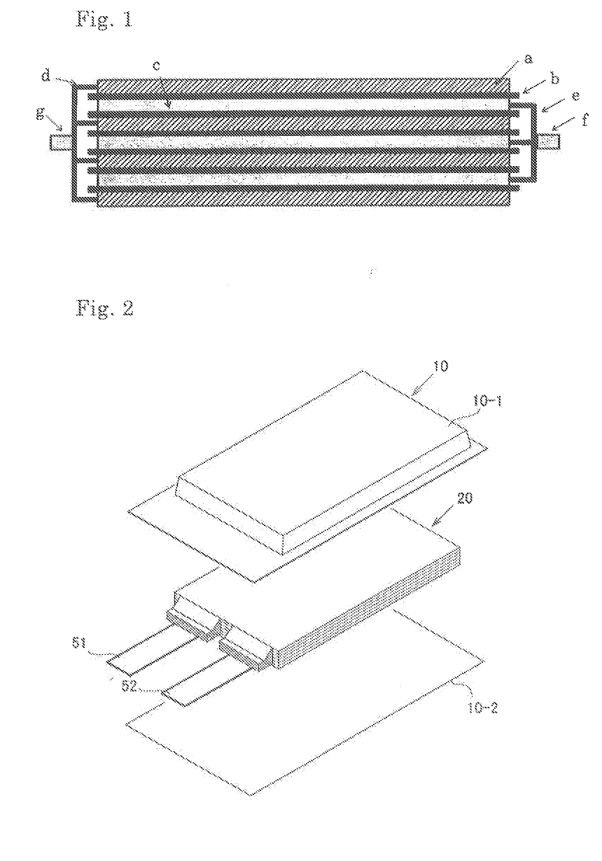

FIG. 1 is a schematic cross-sectional view illustrating a structure of an electrode element in a stacked laminate type secondary battery. The electrode element is formed by alternately stacking one or a plurality of positive electrodes c and one or a plurality of negative electrodes a with separators b sandwiched therebetween. Positive electrode current collectors e which the respective positive electrodes c have are mutually welded at an end portion not covered with a positive electrode active material to be electrically connected, and a positive electrode terminal f is further welded to the welded portion. Negative electrode current collectors d which the respective negative electrodes a have are mutually welded at an end portion not covered with a negative electrode active material to be electrically connected, and a negative electrode terminal g is further welded to the welded portion.

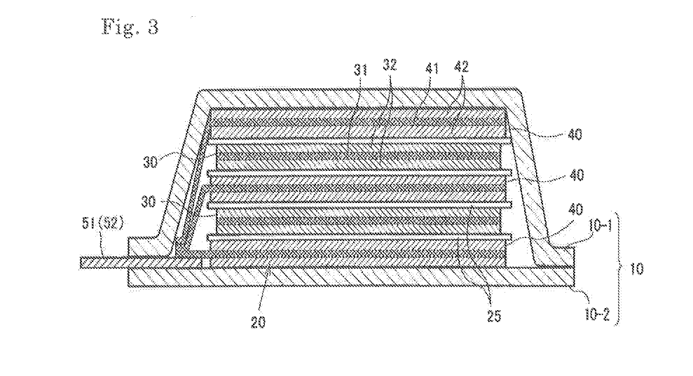

In still another embodiment, a secondary battery having structure as shown in FIG. 2 and FIG. 3 may be provided. This secondary battery comprises a battery element 20, a film package 10 housing the battery element 20 together with an electrolyte, and a positive electrode tab 51 and a negative electrode tab 52 (hereinafter these are also simply referred to as “electrode tabs”).

In the battery element 20, a plurality of positive electrodes 30 and a plurality of negative electrodes 40 are alternately stacked with separators 25 sandwiched therebetween as shown in FIG. 3. In the positive electrode 30, an electrode material 32 is applied to both surfaces of a metal foil 31, and also in the negative electrode 40, an electrode material 42 is applied to both surfaces of a metal foil 41 in the same manner.

In the secondary battery in FIG. 1, the electrode tabs are drawn out on both sides of the package, but a secondary battery to which the present invention may be applied may have an arrangement in which the electrode tabs are drawn out on one side of the package as shown in FIG. 2. Although detailed illustration is omitted, the metal foils of the positive electrodes and the negative electrodes each have an extended portion in part of the outer periphery. The extended portions of the negative electrode metal foils are brought together into one and connected to the negative electrode tab 52, and the extended portions of the positive electrode metal foils are brought together into one and connected to the positive electrode tab 51 (see FIG. 3). The portion in which the extended portions are brought together into one in the stacking direction in this manner is also referred to as a “current collecting portion” or the like.

The film package 10 is composed of two films 10-1 and 10-2 in this example. The films 10-1 and 10-2 are heat-sealed to each other in the peripheral portion of the battery element 20 and hermetically sealed. In FIG. 3, the positive electrode tab 51 and the negative electrode tab 52 are drawn out in the same direction from one short side of the film package 10 hermetically sealed in this manner.

Of course, the electrode tabs may be drawn out from different two sides respectively. In addition, regarding the arrangement of the films, in FIG. 2 and FIG. 3, an example in which a cup portion is formed in one film 10-1 and a cup portion is not formed in the other film 10-2 is shown, but other than this, an arrangement in which cup portions are formed in both films (not illustrated), an arrangement in which a cup portion is not formed in either film (not illustrated), and the like may also be adopted.

### EXAMPLES

Hereinafter, examples of the present embodiment will be explained in details, but the present embodiment is not limited to these examples.

### Examples 1 and 2

### (Production of Positive Electrode)

Firstly, powder of MnO₂, NiO, Li₂CO₃ and TiO₂ was used to weighed so as to be the intended composition ratio and was pulverized and mixed. Subsequently, the mixed powder was calcined at 750° C. for 8 hours to produce LiNi_{0.5}Mn_{1.37}Ti_{0.13}O₄. This positive electrode active material was confirmed to have a substantially single-phase, spinel, structure. The prepared positive electrode active material and carbon black which is a conductive assisting agent were mixed, the mixture was dispersed in a solution in which polyvinylidone fluoride (PVDF) as a binder was dissolved in N-methylpyrrolidone, to prepare a positive electrode slurry. The mass ratio of the positive electrode active material, the conductive assisting agent, and the positive electrode binder was set to 93/3/4. The positive electrode slurry was uniformly applied on one side of a current collector composed of Al. Subsequently, the resultant was dried in vacuum for 12 hours and was subjected to a compression-molding by a roll press to produce a positive electrode. Herein, the weight of the positive electrode active material layer per unit area after drying was set to 0.020 g/cm².

### (Production of Negative Electrode)

Artificial graphite was used as the negative electrode active material. The artificial graphite was dispersed in a solution where PVDF was dissolved N-methylpyrrolidone, to prepare a negative electrode slurry. The mass ratio of the negative electrode active material and the binder was 90/10. This negative electrode slurry was applied on a Cu current collector having a thickness of 20 μm. Herein, the weight of the negative electrode active material layer per unit area after drying was set to 0.0082 g/cm². After drying, the resultant was subjected to a compression-molding by a roll press to produce a negative electrode.

### (Non-Aqueous Electrolyte Solution)

A solution where ethylene carbonate (EC) as a cyclic carbonate, 1,1,2,2-tetrafluoroethyl 2,2,3,3-tetrafluoropropyl ether (FE1) as a fluorinated ether, tris(2,2,2-trifluoroethyl) phosphate (FP1) as a fluorinated phosphate ester were mixed at a ratio of EC/FE1/FP1=30/40/30 (volume ratio) was used as a non-aqueous electrolyte solution. LiPF₆ was dissolved in the solution at a concentration of 1.0 mol/l to prepare an electrolyte solution,.

### (Separator)

In Example 1, a separator consisting of aramid nonwoven fabric and having a thickness of 25 μm was used. This aramid nonwoven fabric separator had a porosity of 72% and showed, a Gurley value of 1.4 seconds, in Example 2, a separator consisting of aramid microporous film and having a thickness of 15 μm was used. This aramid microporous film separator had a porosity of 65% and showed a Gurley value of 80 seconds.

### (Production of Laminate-Type Battery)

The positive electrode and the negative electrode were cut into 1.5 cm×3 cm. The five positive electrode layers and six negative electrode layers obtained were alternately laminated while in Example 1, the aramid nonwoven fabric separators and in Example 2, the aramid microporous film separators were sandwiched therebetween. The ends of the positive electrode current collector not covered with the positive electrode active material and the ends of the negative electrode current collector not covered with the negative electrode active material were each welded, and a positive electrode terminal made of aluminum and a negative electrode terminal made of nickel were each further welded to the welded parts to thereby obtain an electrode element having a flat laminate structure. The electrode element was enclosed with an aluminum laminate film that serves as an outer package, then electrolyte solution was injected into the internal of outer package, subsequently the outer package was sealed under reduced pressure to thereby produce a secondary battery.

### (Conditioning)

The initial charge and discharge (conditioning) of the obtained secondary battery was carried out. In the first charge, a constant current and constant voltage (CCCV) charge of 0.2 C was carried out up to 4.75 V such that total time is 10 hours, and a constant current (CC) discharge of 0.2 C was carried out up to 3 V. The second charge was also carried out in the same way, and the battery was discharged up to 3V after stored for two days in a state where it was discharged up to a discharge depth of 80%.

### (3C Rate Characteristics Evaluation)

3C rate characteristics of the fabricated secondary battery were evaluated. The evaluation was carried out as follows. First, the battery charged to full charge was discharged at a 1C rate (60 min discharge) to 2.5 V to evaluate the discharge capacity. Then, the battery was again charged to full charge, and thereafter discharged at a 3C rate (at a current value three times that of the 1C rate, 20 min discharge) to 2.5 V to evaluate the discharge capacity. Then, 3C/1C rate characteristics (%) were determined from the acquired 3C-discharge capacity and 1C discharge capacity. The results were shown in Table 1.

“Rate characteristics 3C/1C” of Table 1 represents (3C discharge capacity)/(1C discharge capacity)×100 (unit: %).

### (High Temperature Cycle Test)

A cycle test at 45° C. was carried out on the cell where the conditioning was conducted under the same condition as the above cell. A cycle of carrying out a constant voltage charge for 2.5 hours in total after charging by 1 C up to 4.75 V and carrying out a constant current discharge by 1 C up to 3.0 V was repeated 100 times at 45° C. The proportion of the discharge capacity after 100 cycles to the initial discharge capacity was determined as the capacity retention rate. The capacity retention rate (unit: %) after 100 cycles was shown in Table 1.

### Comparative Examples 1 to 3

Batteries were produced as in Example 1 except that polypropylene (PP), polyethylene (PE) and cellulose were used for the separators, and respectively, 3C rate characteristics evaluation and high temperature cycle test were carried out.

TABLE 1

| | | | Comparative | Comparative | Comparative |
|---|---|---|---|---|---|
| | Example 1 | Example 2 | example 1 | example 2 | example 3 |
| Positive | 5 V class | 5 V class | 5 V class | 5 V class | 5 V class |
| electrode | spinel | spinel | spinel | spinel | spinel |
| Negative | Graphite | Graphite | Graphite | Graphite | Graphite |
| electrode | | | | | |
| Electrolyte | EC/FE1/FP1 | EC/FE1/FP1 | EC/FE1/FP1 | EC/FE1/FP1 | EC/FE1/FP1 |
| solution | | | | | |
| Separator | Aramid | Aramid | PP | PE | Cellulose |
| Rate | 65% | 59% | 55% | 45% | 58% |
| characteristics, | | | | | |
| 3 C/1 C | | | | | |
| Capacity | 80% | 80% | 80% | 40% | 80% |
| retention rate | | | | | |
| after 100 | | | | | |
| cycles at 45° C. | | | | | |

The structure, porosity, thickness and Gurley value of the separators used in Examples 1 and 2 and Comparative examples 1 to 3 are shown in Table 2.

TABLE 2

| | | | | | Comparative | | Comparative | Comparative | |
|---|---|---|---|---|---|---|---|---|---|
| | Example 1 | | Example 2 | | example 1 | | example 2 | example 3 | |
| Separator | Aramid | | Aramid | | PP | | PE | Cellulose | |
| Structure | Nonwoven | | Microporous | | Microporous | | Microporous | Nonwoven | |
| | fabric | | | | | | | fabric | |
| Porosity | 72% | | 65% | | 55% | | 88% | 71% | |
| Thickness | 25 | μm | 15 | μm | 25 | μm | 40 μm | 20 | μm |
| Gurley value | 1.4 | sec | 80 | sec | 150 | sec | . | 6 | sec |

According to Table 1, it can be confirmed that regarding the lithium ion secondary batteries of Examples 1 and 2 using the separator consisting of aramid, the capacity retention ratio was kept as high as 80% even after 100 cycles at 45° C. and also, the rate characteristics were more improved than the lithium ion secondary batteries using the separator of another material. The structure, porosity, thickness and Gurley value of each separator were shown in Table 2 but in the case of using the separators consisting of aramid, the rate characteristics, 1C/3C were high even if the Gurley values were high. It is considered that rate characteristics depend on materials of separator than pore structure of separator. It is considered that electrolyte solutions using fluorinated ethers and fluorinated phosphate esters show high viscosity and the impregnation into the pores is slightly difficult but in the case of aramid separator, the wettability to such electrolyte solutions is high and the impregnation is easy,

### Examples 3 and 4

### (Production of Positive Electrode)

Li(Li_{0.2}Ni_{0.2}Mn_{0.6})O₂ which is a Li-rich layered positive electrode was used for the positive electrode active material. The positive electrode active material and carbon black which is a conductive assisting agent were mixed and dispersed in a solution in which polyvinylidene fluoride (PVDF) as a binder was dissolved in N-methylpyrrolidone, to prepare positive electrode slurry. The mass ratio of the positive electrode active material, the conductive assisting agent, and the positive electrode binder was 93/3/4. The positive electrode slurry was uniformly applied on one side of a current collector composed of Al. Subsequently, the resultant was dried in vacuum for 12 hours and was subjected to a compression-molding by a roll press to produce a positive electrode. Herein, the weight of the positive electrode active material layer per unit area after drying was set to 0.020 g/cm².

### (Production of Negative Electrode)

SiO which is a silicon oxide was used as the negative electrode active material. The surface of this SiO was coated with carbon and the mass ratio of the carbon and Si was 95/5. The SiO was dispersed In a solution in which polyimide as a binder was dissolved, in N-methylpyrrolidone to prepare negative electrode slurry. The mass ratio of the negative electrode active material and the hinder was 85/15. The negative electrode slurry was uniformly applied onto a stainless steel current collector having a thickness of 8 μm. Herein, the weight of the negative electrode active material layer per unit area after drying was set to 0.003 g/cm². After drying, the polyimide was cured at 350° C. under a nitrogen atmosphere to produce a negative electrode.

### (Non-Aqueous Electrolyte Solution)

A solution where ethylene carbonate (EC) as a cyclic carbonate, 1,1,2,2-tetrafluoroethyl 2,2,3,3-tetrafluoropropyl ether (FE1) as a fluorinated ether compound, diethyl sulfone (SL) as a sulfone compound were mixed at a ratio of EC/SL/FE1=5/30/65 (volume ratio) was used as a non-aqueous electrolyte solution. LiPF₆ was dissolved in the solution at a concentration of 0.8 mol/l to prepare an electrolyte solution.

### (Separator)

In Example 3, the same separator was used as Example 1 and in Example 4, the same separator was used as Example 2.

### (Production of a Laminate-Type Battery)

The secondary batteries of Examples 3 and 4 were produced using the above positive electrode and negative electrode in the same way as Example 1

### (Conditioning)

The initial charge and discharge (conditioning) of the obtained secondary battery was carried out. In the first charge, a constant current and constant voltage (CCCV) charge of 0.1 C was carried out up to 4.5 V such that total time is 10 hours, and a constant current (CC) discharge of 0.1 C was carried out up to 3 V. The second charge was also carried out in the same way.

### (3C Rate Characteristics Evaluation)

3C rate characteristics of the fabricated secondary battery were evaluated. 1C current rate for the rate characteristics evaluation, which can be discharged in one hour, was determined from the discharge capacity of the second discharge in the conditioning. The evaluation was carried out as follows. First, the battery charged to full charge was discharged at a 1C rate (60 min discharge) to 2 V to evaluate the discharge capacity. Then, the battery was again charged to full charge, and thereafter discharged at a 3C rate (at a current value three times that of the 1C rate, 20 min discharge) to 2 V to evaluate the discharge capacity. Then, 3C/1C rate characteristics (%) were determined from the acquired 3C discharge capacity and 1C discharge capacity. The results were shown in Table 3.

“Rate characteristics 3C/1C” of Table 3 represents (3C discharge capacity)/(1C discharge capacity)×100 (unit: %).

### (High Temperature Cycle Test)

A cycle test was carried out at 45° C. on the cell where the conditioning was conducted under the same condition as the above cell. A cycle of carrying out a constant current discharge by 0.5 C up to 2.0 V after charging a battery by 0.5 C up to 4.5 V was repeated 100 times at 45° C. The proportion of the discharge capacity after 100 cycles to the initial discharge capacity was determined as the capacity retention rate. The capacity retention rate (unite: %) after 100 cycles was shown in Table 3.

### Comparative Examples 4 to 6

Batteries were produced as in Example 3 except that polypropylene (PP), polyethylene (PE) and cellulose were used for the separators, and respectively, 3C rate characteristics evaluation and high temperature cycle test were carried out. The results were shown in Table 3.

TABLE 3

| | | | Comparative | Comparative | Comparative |
|---|---|---|---|---|---|
| | Example 3 | Example 4 | example 4 | example 5 | example 6 |
| Positive | Li-rich | Li-rich | Li-rich | Li-rich | Li-rich |
| electrode | layered | layered | layered | layered | layered |
| Negative | SiO | SiO | SiO | SiO | SiO |
| electrode | | | | | |
| Electrolyte | EC/SL/FE1 | EC/SL/FE1 | EC/SL/FE1 | EC/SL/FE1 | EC/SL/FE1 |
| solution | | | | | |
| Separator | Aramid | Aramid | PP | PE | Cellulose |
| Rate | 59% | 56% | 45% | 36% | 48% |
| characteristics, | | | | | |
| 3 C/1 C | | | | | |
| Capacity | 78% | 78% | 74% | 35% | 73% |
| retention rate | | | | | |
| after 100 | | | | | |
| cycles at 45° C. | | | | | |

The structure, porosity, thickness and Gurley value of the separators used in Examples 3 and 4 and Comparative examples 4 to 6 are shown in Table 4.

TABLE 4

| | | | | | Comparative | | Comparative | Comparative | |
|---|---|---|---|---|---|---|---|---|---|
| | Example 3 | | Example 4 | | example 4 | | example 5 | example 6 | |
| Separator | Aramid | | Aramid | | PP | | PE | Cellulose | |
| Structure | Nonwoven | | Microporous | | Microporous | | Microporous | Nonwoven | |
| | fabric | | | | | | | fabric | |
| Porosity | 72% | | 65% | | 55% | | 88% | 71% | |
| Thickness | 25 | μm | 15 | μm | 25 | μm | 40 μm | 20 | μm |
| Gurley value | 1.4 | sec | 80 | sec | 150 | sec | . | 6 | sec |

According to Table 3, it can be confirmed that regarding the lithium ion secondary batteries of Examples 3 and 4 using the separator consisting of aramid, the capacity retention ratio was kept as high as 75% or more even after 100 cycles at 45° C. and also, the rate characteristics were more improved than the lithium ion secondary batteries using the separator of another materials. The similar effects to Examples 1 and 2 could be confirmed. It is considered that the similar effects were also obtained in the case of changing the positive electrode materials and the negative electrode materials.

### INDUSTRIAL APPLICABILITY

The lithium ion secondary battery of the present invention can be utilized in various industrial fields that require for an electric power source and in an industrial field concerning transportation, storage and supply of electric energy. Specifically, it can be utilized for, for example, an electric power source of a mobile device such as a mobile phone and a notebook computer; an electric power source of a moving or transport medium including an electric vehicle such as an electric car, a hybrid car, an electric motorcycle and an electric power-assisted bicycle, a train, a satellite and a submarine; a back-up electric power source such as UPS; and an electric power storage device for storing an electric power generated by solar power generation, wind power generation, and the like.

### EXPLANATION OF REFERENCE

a: negative electrode
b: separator
c: positive electrode
d: negative electrode current collector
e: positive electrode current collector
f: positive electrode terminal
g: negative electrode terminal
10: film outer package
20: battery element
25: separator
30: positive electrode
40: negative electrode

1. A lithium ion secondary battery having
an electrolyte solution comprising one or more compounds selected from a fluorinated ether denoted by the following formula (1) and a fluorinated phosphate ester denoted by the following formula (2), and
a separator comprising an aramid resin;
R₄—O—R₅ (1)
wherein R₄ and R₅ each independently represent alkyl group or fluorinated alkyl group, and at least one of R₄ and R₅ is fluorinated alkyl group, 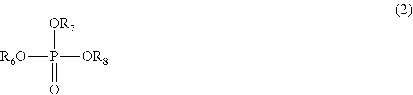
wherein R₆, R₇, and R₈ each independently represent non-substituted or substituted alkyl group, at least one of R₆, R₇, and R₈, is fluorinated alkyl group, and a carbon atom in R₆ and a carbon atom in R₇ may be bonded through a single bond or a double bond to form a cyclic structure.

2. The lithium ion secondary battery according to claim 1, wherein the electrolyte solution comprises the fluorinated ether denoted by the formula (1) in an amount of 5 volume % or more.

3. The lithium ion secondary battery according to claim 1, wherein the electrolyte solution comprises the fluorinated phosphate ester denoted by the formula (2) in an amount of 5 volume % or more.

4. The lithium ion secondary battery according to claim 1, wherein the separator comprises the aramid resin in an amount of 50 mass % or more.

5. The lithium ion secondary battery according to claim 1, wherein the separator has a porosity of 55% or more.

6. The lithium ion secondary battery according to claim 1, wherein the separator has a film thickness of 30 μm or less.

7. The lithium ion secondary battery according to claim 1, wherein it has a positive electrode operable at a potential of 4.5V or higher vs. Lithium.

8. The lithium ion secondary battery according to claim 1, wherein the positive electrode comprises a lithium manganese composite oxide denoted by the following formula (6) or (7);
Liₐ(MₓMn_{2-x-y}Y_{y})(O_{4-w}Z_{w}) (8)
wherein 0.4≦x≦1.2, 0≦y, x+y<2, 0≦a≦1.2, 0≦w≦1, M is at least one selected from the group consisting of Co, Ni, Fe, Cr, and Cu, Y is at least one selected from the group consisting of Li, B, Na, Mg, Al, Ti, Si, K, and Ca, and Z is at least one of F and Cl,
Liₐ(LiₓM_{1-x-z}Mn_{z})O₂ (7)
wherein 0≦x<0.3, 0.3≦z≦0.7, 0≦a≦1 and M is at least one selected from Co, Ni, and Fe.

9. A vehicle comprising the lithium ion secondary battery according to claim 1.

10. (canceled)

11. A method of producing a secondary battery comprising:
a step of stacking a positive electrode and a negative electrode via a separator to produce an electrode element and
a step of enclosing the electrode element and an electrolyte solution in an outer package, wherein
the electrolyte solution comprises the fluorinated ether denoted by the formula (1) of claim 1 and the fluorinated phosphate ester denoted by the formula (2) of claim 1, and the separator comprises an aramid resin.
